(19) United States
(12) Patent Application Publication
(10) Pub. No.: US 2006/0147598 A1
(43) Pub. Date: Jul. 6, 2006

(54) Frozen muffin preform

(76) Inventors: Wei Lu, Ballwin, MO (US); Yue Liao, Chesterfield, MO (US); Jerry Belton, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 11/274,490

(22) Filed: Nov. 15, 2005

Related U.S. Application Data
(60) Provisional application No. 60/627,849, filed on Nov. 15, 2004.

(51) Int. Cl. A21D 10/00

(52) U.S. Cl. 426/549

(57) ABSTRACT

A frozen muffin pre-form is made from a batter comprising flour, sugar, baking soda, water, and sufficient gelatin to maintain the shape of the pre-form until the gelatin release water and the pre-form melts in the oven. The muffin pre-form can be baked into a muffin by placing the frozen muffin pre-form on a baking pan, and baking the pre-form directly from its frozen state. The pre-form has a substantial storage time in the freezer, and quickly and easily baked into fresh-baked muffins by someone without any baking skills or experience.

### CROSS-REFERENCE TO RELATED APPLICATIONS

This application claims the benefit of U.S. Provisional Application No. 60/627,849, filed on Nov. 15, 2004. The disclosure of the above application is incorporated herein by reference.

### BACKGROUND OF THE INVENTION

This invention relates to frozen batters for baking, and in particular to a frozen muffin pre-form that can be conveniently baked into fresh-baked muffins.

### SUMMARY OF THE INVENTION

Various embodiments of the present invention provide a frozen muffin pre-forms that can be stored frozen and used to make one or more fresh-baked muffins. Generally the frozen muffin pre-form of the preferred embodiment is made from a batter comprising flour, sugar, baking soda, water, and gelatin. The gelatin builds the shape of the pre-form when the pre-form is processed, and liquidates to generate volume when the pre-form is baked into a muffin. The batter preferably has a gelatin content of between about 0.4 percent and about 1.1 percent by weight. The ratio of gelatin to water in the batter is preferably between about 0.015 and about 0.055.

In the preferred embodiment, the frozen muffin pre-form is adapted to be baked into a muffin directly from its frozen state, and comprises between about 22.0 percent and about 35.5 percent flour; between about 5.0 percent and about 14.0 percent sucrose; between about 9.5 percent and about 14.5 percent corn syrup; water; baking soda; and gelatin.

The pre-forms are preferably disc shaped and sized to fit in a conventional muffin pan, and more preferably in a conventional muffin cup in a muffin pan. According to the method of this invention, a frozen muffin pre-form made from a batter containing gelatin is placed in a baking pan and baked directly from its frozen state. In the oven the batter softens, gradually losing its shape and baking into a muffin. The gelatin holds water when the batter is cold, and gradually releases water during the baking process as the batter warms in the oven. Thus, as the batter warms it remains as a mixed batter and does not significantly separate.

Making traditional batters for muffins from scratch or a dry mix requires the assembly of numerous ingredients. It is time consuming to measure, blend, and mix the ingredients into a homogenous batter, and portion the batter into the proper amounts to bake into muffins. Afterwards, the utensils must be cleaned. In contrast, the pre-forms of the present invention can be conveniently handled and stored, and the consumer can select the desired quantity of muffins and quickly and easily make a desired quantity of fresh-baked muffins without the time and effort of making batter from scratch. These and other features and advantages will be in part apparent, and in part pointed out hereinafter.

### BRIEF DESCRIPTION OF THE DRAWINGS

FIG. 1 is a perspective view of a muffin pre-form in accordance with the principles of this invention;

FIG. 2 is a photograph of a plurality of muffin pre-forms prior to baking;

FIG. 3 is a photograph of a plurality of muffin pre-forms disposed in conventional paper baking cups in a muffin pan, prior to baking;

FIGS. 4A-4D are a photographs of a plurality of muffin pre-forms taken successively while the pre-forms were being baked into muffins; and

FIG. 5 is a photograph of muffins baked from the pre-forms.

### DETAILED DESCRIPTION OF THE PREFERRED EMBODIMENT

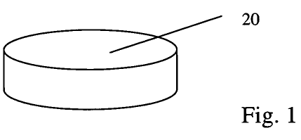

A preferred embodiment of a muffin pre-form in accordance with the principles of this invention is indicated generally as 20 in FIG. 1. The pre-form 20 is preferably disk-shaped with a diameter of between about 1.5″ and about 2.5″, and a thickness of between about 0.75″ and about 1.5″. The muffin pre-form is preferably frozen so that it retains its shape, can be packaged in bulk without the need for individual wrapping, and it can be stored for a relatively long period of time.

The muffin pre-form is preferably made from a batter comprising flour, sugar, baking soda, water, and sufficient gelatin to build and maintain the shape of the pre-form when the pre-form is processed, and release water as the pre-form is baked into a muffin. The gelatin content of the batter is preferably between about 0.4 percent and about 1.1 percent by weight. The ratio of gelatin to water in the batter is preferably between about 0.015 and about 0.055. The invention of the preferred embodiment takes advantage of the unique properties of gelatin, particularly the thermo-reversiblility, to produce convenient and stable frozen batters. The batter can be extruded into individual pre-forms or “pucks” for baking into muffins and provides high quality baked goods that are similar to those prepared either from scratch or a dry mix.

Besides its binding power and function as a plasticizer, gelatin has the ability to form a thermo-reversible gel. When heated to about 50° C. to about 60° C., it dissolves, and forms a gel when cooled. This sol-gel conversion is reproducible and can be repeated several times. These important characteristics are used in the invention to plasticize muffin batter during mixing, which facilitates the extrusion and cutting of the muffin pre-forms, binds pucks at low temperature, and stabilizes the firmness during packaging, freeze-thaw cycles, panning, and baking. Eventually the gelatin liquefies and releases the binding water in the oven, which allows the volume generated for muffin, and may even set muffin structure by re-gelling during the cooling after baking.

The flour content of the batter is preferably between about 22.0 percent and about 35.5 percent.

The batter preferably further comprises corn syrup, and more preferably both high fructose corn syrup and corn syrup. The high fructose corn syrup content is preferably between about 9.5 percent and about 14.5 percent. The ratio of the high fructose corn syrup to sucrose ratio is between about 0.35 and about 0.65. The sucrose to water ratio is between about 0.35 and 0.55. The sucrose content of the batter is between about 5.0 percent and about 14.0 percent.

The baking soda content of the batter is between 0.35 percent and about 0.55 percent. The batter preferably further comprises an emulsifier. The emulsifier content of the batter is preferably between about 0.70 percent and about 1.10 percent. The batter preferably further comprises shortening. The shortening content of the batter is preferably between about 7.0 percent and about 14.0 percent. The muffin pre-form preferably further comprises gum. The gum content is preferably between about 0.05 percent and about 0.17 percent.

The baking soda content of the batter is between about 0.35 percent and about 0.55 percent. The batter preferably also comprises SALP. The SALP content is between about 0.35 percent and about 0.85 percent.

The pH of the batter is preferably between about 6.0 and about 7.0. The specific gravity of the batter is preferably between about 0.75 and about 1.15.

The gelatin helps to retain the shape of the perform as the perform 20 thaws during the baking process. The gelatin also helps retain water in the batter, preventing the batter from separating as the pre-from thaws and bakes into a muffin.

The frozen muffin pre-form comprises between about 22.0 percent and about 35.5 percent flour; between about 5.0 percent and about 14.0 percent sucrose; between about 9.5 percent and about 14.5 percent high fructose corn syrup; water; baking soda; and gelatin. A preferred range of the various ingredients is set forth in Table 1:

TABLE 1

Water: 22-32%
Sucrose: 5.0-14.0%
High Fructose Corn Syrup (HFCS): 9.5-14.5%
Corn Syrup (63DE): 0.0-1.2%
HFCS/Sucrose: 0.85-1.56
HFCS/Water: 0.30-0.65
Sucrose/Water: 0.25-0.50
Wheat Flour: 22.0-35.5%
High Ratio Cake Flour/Patent Flour: 0.81.4
Baking Soda: 0.35-0.55%
Sodium Aluminum Phosphate (SALP): 0.35-0.85%
Emulsifier: 0.70-1.10%
Shortening: 7.0-14.0%
Gum: 0.05-0.17%
Gelatin: 0.4-1.1%
Gelatin/Water: 0.015-0.055

### EXAMPLE 1

A muffin pre-form is prepared with the following recipe:

| INGEDIENTS | PARTS BY WEIGHT |
|---|---|
| GRANULATED SUGAR | 200.0 |
| HI RATIO CAKE FLOUR BULK | 300.0 |
| PATENT FLOUR BULK | 310.0 |
| MYVATEX TEXTURE LITE K | 7.0 |
| INST CLEARGEL/POLARGEL CS | 8.0 |
| SSL | 8.0 |
| BAKING SODA | 10.0 |
| SALT FINE FLAKE | 8.5 |
| SUPRO 1100 | 15.0 |
| XANTHAN GUM | 1.2 |
| EGG WHITE SOLIDS | 20.0 |
| DRY WHOLE EGGS | 15.0 |
| LHMPC | 20.0 |
| CT HS SHORTENING | 220.0 |
| POLYSORBARE 60 | 6.0 |
| SUCRALOSE LIQUID | 0.50 |
| WATER | 510.0 |
| HI FRUTOSE CORN SYRUP | 260.0 |
| Corn Syrup 63 DE | 20.0 |
| CHOCOL FLAV | 3.0 |
| Salad oil | 50.0 |
| Gelatin 250 Bloom (Type A) | 15.0 |
| SALP | 11.0 |
| CHOCOLATE CHIPS | 170.0 |
| TOTAL | 2188.2 |

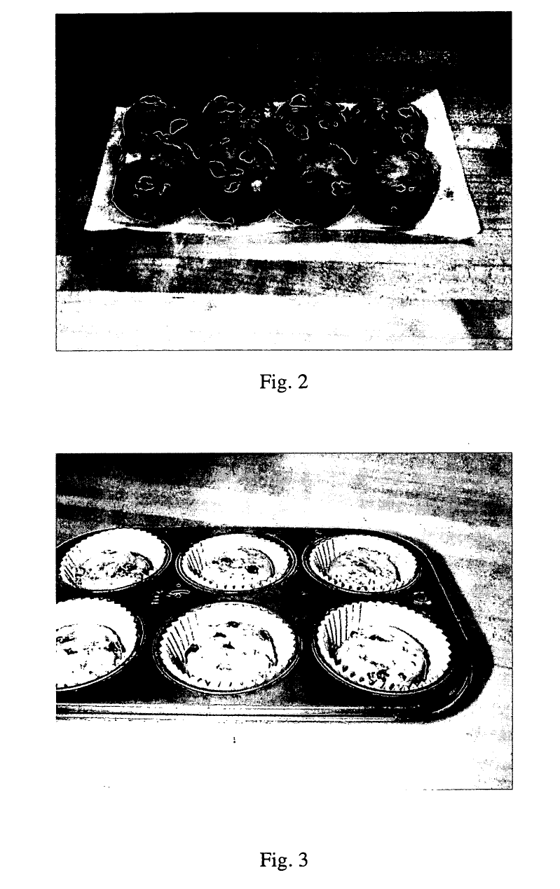

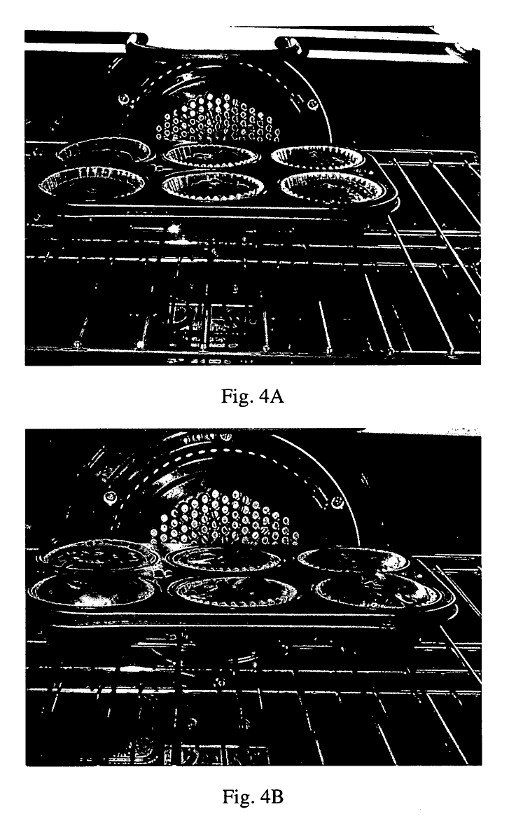

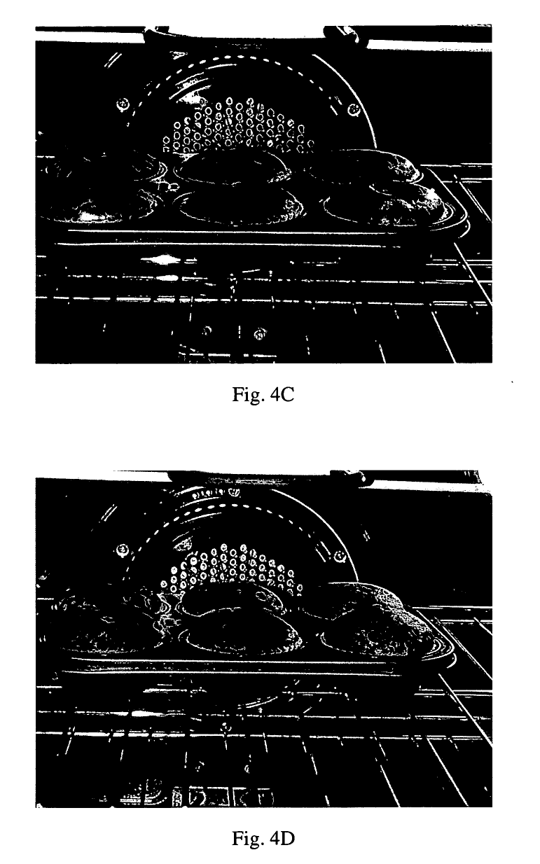

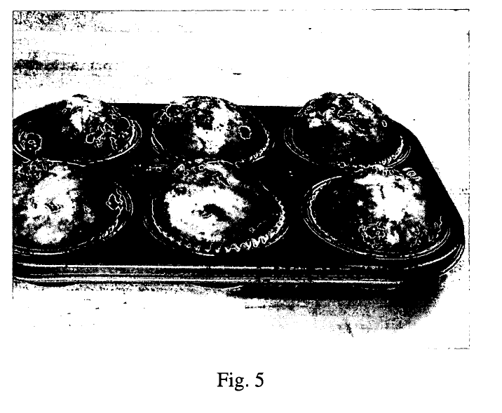

The ingredients selected to result in a batter pH of between about 6.0 and about 7.0, a specific gravity of between about 0.75 and about 1.15%, and a final batter temperature of between about 60° F. and about 75° F. The dough was extruded and cut into disk shaped pre-forms which were frozen. These muffin pre-forms were then frozen (see FIG. 2). After freezing the muffin pre-forms were individually placed in conventional paper muffin cups in a muffin pan (see FIG. 3), and baked into muffins in a conventional home-style oven at 375° for 27 to 29 minutes (see FIGS. 4A-4D). This resulted in freshly baked muffins of comparable appearance and texture of muffins baked directly from batter (see FIG. 5).

A method of making a muffin in accordance with the principles of this invention comprises: placing a frozen muffin pre-form on a baking pan; and baking the pre-form on the baking pan directly from its frozen state, at a rate that sufficient heat would penetrate into the puck center while not burning the puck surface. In the preferred embodiment, the frozen muffin pre-form is placed in a convention muffin cup in the muffin pan.

The pre-forms can be taken directly from the freezer to the oven, without the need to make muffin batter from scratch, or measure out portions, and clean up afterward. The use can select as few or as many muffins to bake. The pre-forms have a substantial storage time in the freezer, and quickly and easily baked into fresh-baked muffins by someone without any baking skills or experience.

What is claimed is:

1. A frozen muffin pre-form made from a batter comprising flour, sucrose, baking soda, water, and sufficient gelatin to bind the batter together in a pre-form, and release sufficient water to reconstitute the batter as the pre-form melts during baking.

2. The frozen muffin pre-form according to claim 1 wherein the gelatin content of the batter is between about 0.4 percent and about 1.1 percent by weight

3. The frozen muffin pre-form according to claim 2 wherein the ratio of gelatin to water in the batter is between about 0.015 and about 0.055.

4. The frozen muffin pre-form according to claim 1 wherein the flour content of the batter is between about 22.0 percent and about 35.5.

5. The frozen muffin pre-form according to claim 1 wherein the batter further comprises corn syrup.

6. The frozen muffin pre-form according to claim 5 where the corn syrup includes both high fructose corn syrup and corn syrup.

7. The frozen muffin pre-form according to claim 6 wherein the high fructose corn syrup content is between about 9.5 percent and about 14.5 percent.

8. The frozen muffin pre-form according to claim 6 wherein the ratio of the high fructose corn syrup to sucrose ratio is between about 0.85 and about 1.56.

9. The frozen muffin pre-form according to claim 1 wherein the sucrose to water ratio is between about 0.25 and 0.50.

10. The muffin pre-form according to claim 1 wherein the sucrose content of the batter is between about 5.0 percent and about 14.0 percent.

11. The muffin pre-form according to claim 1 wherein the baking soda content of the batter is between 0.35 percent and about 0.55 percent.

12. The muffin pre-form according to claim 1 wherein the batter further comprises an emulsifier.

13. The muffin pre-form according to claim 12 wherein the emulsifier content of the batter is between about 0.70 percent and about 1.10 percent.

14. The muffin pre-form according to claim 1 wherein the batter further comprises shortening.

15. The muffin pre-form according to claim 14 wherein the shortening content of the batter is between about 7.0 percent and about 14.0 percent.

16. The muffin pre-form according to claim 1 further comprising gum.

17. The muffin pre-form according to claim 16 wherein the gum content is between about 0.05 percent and about 0.17 percent

18. The muffin pre-form according to claim 1 wherein the pH of the batter is between about 6.0 and about 7.0.

19. The muffin pre-form according to claim 1 wherein the specific gravity of the batter is between about 0.75 and about 1.15.

20. A frozen muffin pre-form adapted to be baked into a muffin directly from its frozen state, the pre-form comprising a frozen disk of a batter comprising:
between about 22.0 percent and about 35.5 percent flour;
between about 5.0 percent and about 14.0 percent sucrose;
between about 9.5 percent and about 14.5 percent high fructose corn syrup;
between about 22 percent and about 32 percent water;
baking soda; and
sufficient gelatin to maintain the shape of the pre-form and liquidate pre-form during the baking process.

21. The muffin pre-form according to claim 20 wherein the ratio of high fructose corn syrup to sucrose is between about 0.85 to about 1.56.

22. The muffin pre-form according to claim 21 wherein the ratio of high fructose corn syrup to water is between about 0.35 and about 0.65.

23. The muffin pre-form according to claim 20 wherein the ratio of sucrose to water is between about 0.25 and about 0.50.

24. The muffin pre-form according to claim 20 wherein the baking soda content is between about 0.35 percent and about 0.55 percent.

25. The muffin pre-form according to claim 20 further comprising SALP.

26. The muffin pre-form according to claim 25 wherein the SALP content is between about 0.35 percent and about 0.85 percent.

27. The muffin pre-form according to claim 20 wherein the batter further comprises an emulsifier.

28. The muffin pre-form according to claim 27 wherein the emulsifier content is between about 0.70 percent and about 1.10 percent.

29. The muffin pre-form according to claim 20 wherein the batter further comprises shortening.

30. The muffin pre-form according to claim 29 wherein the batter shortening content is between about 7.0 percent and about 14.0 percent.

31. The frozen muffin pre-form according to claim 20 wherein the gelatin content of the batter is between about 0.4 and about 1.1 percent by weight.

32. The frozen muffin pre-form according to claim 31 wherein the ratio of gelatin to water in the batter is between about 0.015 and about 0.055.

33. A method of making a muffin comprising:
placing a frozen muffin pre-form made from a batter containing gelatin on a baking pan;
Baking the pre-form on the baking pan directly from its frozen state, at a rate that the sufficient heat would cook the center of the pre-form but not burn the muffin surface.

34. The method according to claim 33 wherein pre-form is made from a batter containing between about 0.4 and about 1.1 percent by weight gelatin.

35. The method according to claim 34 wherein the ratio of gelatin to water in the batter is between about 0.015 and about 0.055.
